(19) United States
(12) Patent Application Publication
(10) Pub. No.: US 2014/0101162 A1
(43) Pub. Date: Apr. 10, 2014

(54) METHOD AND SYSTEM FOR RECOMMENDING SEMANTIC ANNOTATIONS

(71) Applicant: INDUSTRIAL TECHNOLOGY RESEARCH INSTIT, Hsinchu (TW)

(72) Inventors: Hsiang-Yuan Hsueh, Hsinchu County (TW); Ko-Li Kan, New Taipei City (TW); Chi-Chou Chiang, Chiayi City (TW)

(73) Assignee: INDUSTRIAL TECHNOLOGY RESEARCH INSTITUTE, Hsinchu (TW)

(21) Appl. No.: 13/647,402

(22) Filed: Oct. 9, 2012

(51) Int. Cl. G06F 17/30

(52) U.S. Cl. 707/739; 707/E17.089

(57) ABSTRACT

A method for recommending semantic annotations on a main document and sub documents is provided. The method includes: extracting a keyword of the main document; extracting a or a set of keyword of each sub document; and generating a or a set of keyword similarity of each of the sub documents based on a degree of similarity between the keyword of the main document and the keyword of each of the sub documents. The method also includes: obtaining a plurality of words appeared on each of the sub documents and calculating a frequency of each of the words; generating a semantic capacity of each of the sub documents according to the frequencies; grouping the main document and at least one of the sub documents into a semantic document set based on the semantic capacities and the keyword similarities; and annotating the main document according to the semantic document set.

### BACKGROUND

1. Technology Field

The present disclosure relates to a method for recommending semantic annotations and a system thereof.

2. Description of Related Art

Transmitting or publishing information though documents is widely adopted. A document usually includes many words, several diagrams or several tables. Typically, a keyword-based approach is used when searching a document. However, searching by using keywords reflecting some general concepts may not always find out specific information. Therefore, for improving the searchability of documents, document annotation technology is a common approach. If some specific data or information is annotated into a document, the annotations could be used when searching, data mining, manipulating a database.

The annotations in a document have to be readable by a computer or a machine. That is, the annotations must comply with a metadata protocol. Currently, the manual approach, called tagging, is still widely applied, but it is very laborious. As a result, how to annotate a document automatically with a metadata protocol is getting extensive attentions. However, for a semi-structured document or a unstructured document, it is hard to get the semantic structure thereof. Thereby, how to develop a method that precisely recommends semantic annotations has become a major subject in the industry.

### SUMMARY

The exemplary embodiments of the disclosure are directed to a method and a system for recommending semantic annotations of a document.

According to an exemplary embodiment of the disclosure, a method for recommending semantic annotations is provided. The method includes: extracting a keyword of the main document; extracting a keyword of each of the sub documents; and generating a keyword similarity of each of the sub documents, wherein the keyword similarity of each of the sub documents is generated based on a degree of similarity between the keyword of the main document and the keyword of each of the sub documents. The method also includes: obtaining a plurality of words appeared on each of the sub documents and calculating a frequency of each of the words appeared on each of the sub documents; generating a semantic capacity of each of the sub documents according to the frequency of each of the words appeared on each of the sub documents; grouping the main document and at least one of the sub documents into a semantic document set based on the semantic capacities of the sub documents and the keyword similarities of the sub documents; and annotating the main document according to the semantic document set.

According to an exemplary embodiment of the disclosure, a system for recommending semantic annotations is provided. The system comprises a processor and a memory storing a plurality of instructions. The processor is coupled to the memory, and is configured to execute the instructions to extract a keyword of the main document; extract a keyword of each of the sub documents; and generate a keyword similarity of each of the sub documents, wherein the keyword similarity of each of the sub documents is generated based on a degree of similarity between the keyword of the main document and the keyword of each of the sub documents. The processor is also configured to execute the instructions to obtain a plurality of words appeared on each of the sub documents and calculate a frequency of each of the words appeared on each of the sub documents; generate a semantic capacity of each of the sub documents according to the frequency of each of the words appeared on each of the sub documents; group the main document and at least one of the sub documents into a semantic document set based on the semantic capacities of the sub documents and the keyword similarities of the sub documents; and annotate the main document according to the semantic document set.

As described above, the method and the system of the exemplary embodiments of the disclosure can precisely annotate a document based on information extracted from a semantic document set instead of a single document.

It should be understood, however, that this Summary may not contain all of the aspects and exemplary embodiments of the present disclosure, is not meant to be limiting or restrictive in any manner, and that the present disclosure as disclosed herein is and will be understood by those of ordinary skill in the art to encompass obvious improvements and modifications thereto.

These and other exemplary embodiments, features, aspects, and advantages of the present disclosure will be described and become more apparent from the detailed description of exemplary exemplary embodiments when read in conjunction with accompanying drawings.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 illustrates a block diagram of a system for recommending semantic annotation according to a first exemplary embodiment.

FIG. 2 is a flowchart of a method for recommending semantic annotations according to the first exemplary embodiment.

FIG. 3 is a flowchart of identifying a concept according to the first exemplary embodiment.

FIG. 4 is a diagram illustrating a semantic document set according to the first exemplary embodiment.

FIG. 5 is a diagram illustrating a curve of frequencies of words according to the first exemplary embodiment.

FIG. 6 is a flowchart of obtaining candidate words related to a document according to the first exemplary embodiment.

FIG. 7 is a schematic diagram illustrating the matching between property names and property values according to the first exemplary embodiment.

FIG. 8 is a flowchart of matching properties according to the first exemplary embodiment.

FIG. 9 is a flowchart of embedding the properties as annotations according to the first exemplary embodiment.

FIG. 10 is a flowchart of a method for recommending semantic annotations according to a second exemplary embodiment.

### DESCRIPTION OF THE EXEMPLARY EMBODIMENTS

Reference will now be made in detail to the present preferred exemplary embodiments of the present disclosure, examples of which are illustrated in the accompanying drawings. Wherever possible, the same reference numbers are used in the drawings and the description to refer to the same or like parts.

### First Exemplary Embodiment

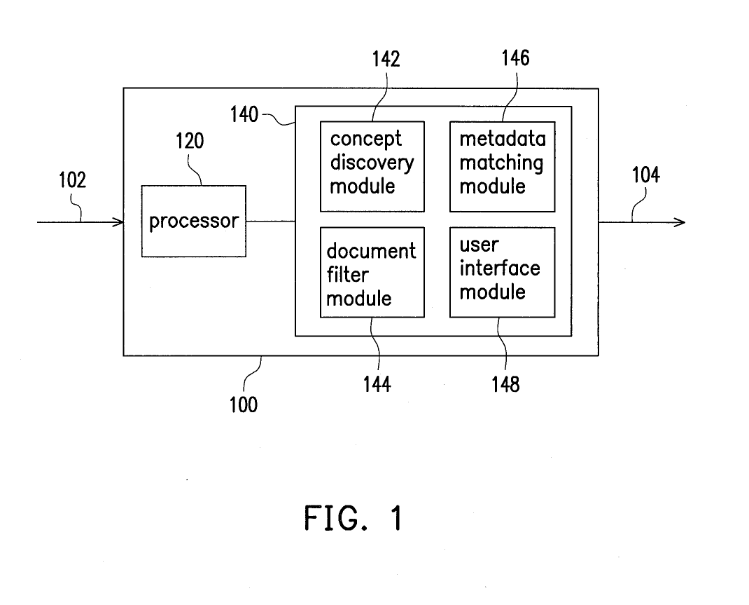

FIG. 1 illustrates a block diagram of a system for recommending semantic annotation according to the first exemplary embodiment.

Referring to FIG. 1. The system 100 receives input documents 102 and generates annotated documents 104. In one exemplary embodiment, the input documents 102 are web pages including a plurality of words, tables or figures. In other exemplary embodiments, the input documents 102 may be files with the format of portable document file (PDF) or files with a “.txt” extensive filename, the disclosure is not limited thereto. The annotated documents 104 contain some extra information complying with a metadata protocol. In one exemplary embodiment, the metadata protocol is microdata defined in HyperText Markup Language (HTML). For example, the content of the input documents 102 is about a celebrity, and the extra information in the annotated documents 104 is a tag of name, address, or title. Therefore, a machine could retrieve the annotated documents 104 according to the tags. However, in other exemplary embodiments, the metadata protocol may be resource description framework (RDF), the disclosure is not limited thereto.

The system 100 includes a processor 120 and a memory 140. In the exemplary embodiment, the processor 120 is a central processing unit (CPU), and the memory 140 is a random access memory. However, the disclosure is not limited thereto, the processor 120 may be a microprocessor, and the memory 140 may be a flash memory. A plurality of instructions are stored in the memory 140, and they are implemented as, but not limited to concept discovery module 142, document filter module 144, metadata matching module 146 and user interface module 148. The processor 120 is configured to execute the modules in the memory 140 to annotate the input documents 102. The function of each of the modules will be described in detail below.

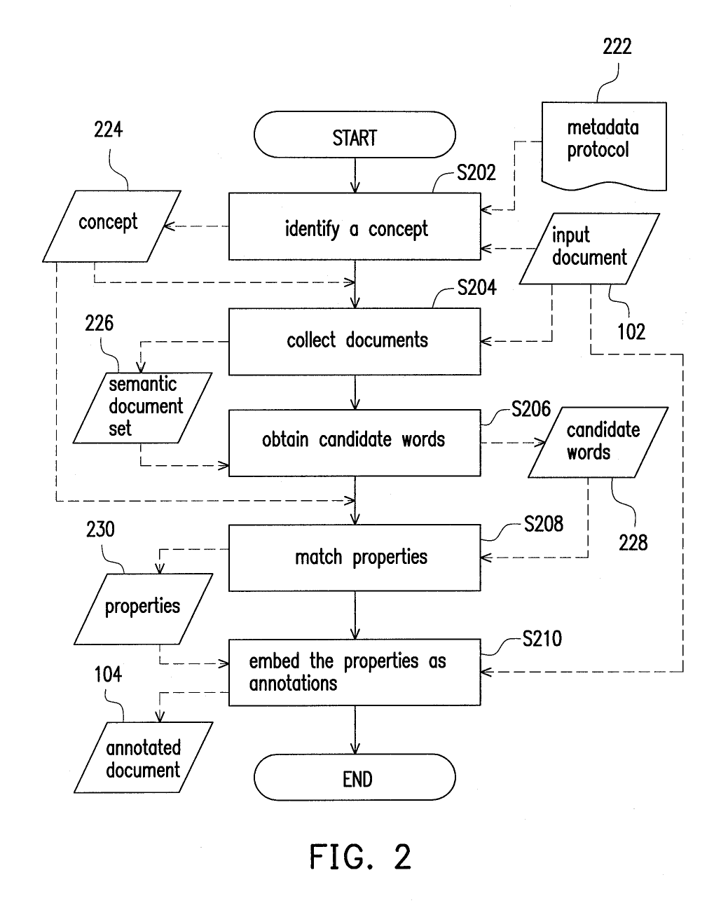

FIG. 2 is a flowchart of a method for recommending semantic annotations according to the first exemplary embodiment.

Referring to FIG. 2. The input documents 102 include a main document. In step S202, the concept discovery module 142 receives the main document and the metadata protocol 222 to identify and find out concepts 224. For example, the metadata protocol 222 is microdata defined in HTML and the concept 224 may be an item type defined in microdata. The item type indicates what the subject of the input document 102 is about. For example, the item type may indicate a person, a product or an organization. It should be noticed that the number of item type may be more than one, the disclosure is not limited thereto.

The input documents 102 further include a plurality of sub documents. In step S204, the document filter module 144 collects documents which semantic meanings are related with the concept 224 from the sub documents. Then, the document filter module 144 generates the semantic document set 226 according to the collected documents. For example, the concept 224 is about a person, and the collected documents may have descriptions of the person. In the exemplary embodiment, the document filter module 144 will annotate the input document 102 according to the semantic document set 226 instead of a single document.

In step S206, the document filter module 144 obtains a plurality of candidate words 228 from the semantic document set 226. The candidate words 228 are more informative than the other words in the semantic document set 226 and have high probabilities to be annotated into the input document 102.

In step S208, the metadata matching module 146 matches the candidate words 228 with properties of the concept 224. For example, when the concept 224 is represented as an item type “person”, the properties of the concept 224 may be name, title, or address. Each property includes a property name and a property value. The metadata matching module 146 matches the candidate words 228 with the properties to identify the property names and property values and generate the properties 230.

In step S210, the metadata matching module 146 embeds the properties 230 into the input document 102 as annotations, and thereby generating the annotated documents 104.

The user interface module 148 shows the annotated documents 104 on a screen (not shown). In other embodiments, the user interface module 148 only shows the recommending properties 230 on the screen, the disclosure is not limited thereto.

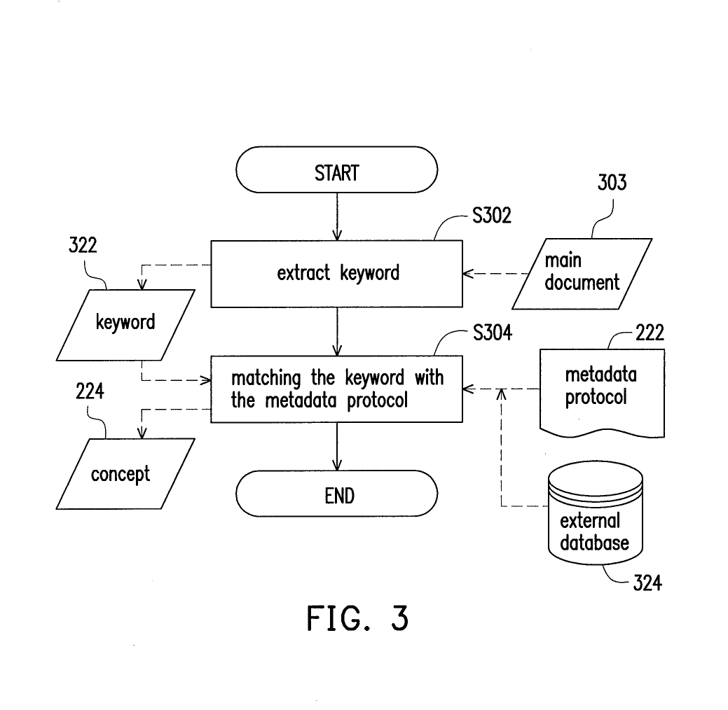

FIG. 3 is a flowchart of identifying a concept according to the first exemplary embodiment.

Referring to FIG. 3. The main document 303 is included in the input documents 102. In step S302, the concept discovery module 142 extracts at least one keyword 322 from the main document 303. The concept discovery module 142 may apply any extracting algorithm, the disclosure does not limit how the keywords 322 are extracted. In step S304, the concept discovery module 142 matches the keyword 322 with the metadata protocol 222 to generate the concept 224. For example, if the keyword 322 is “Bob”, then it is matched to a item type “person” defined in the metadata protocol 222. In other words, the concept 224 may be represented as an item type “person”. The concept discovery module 142 may also utilize the external database 324 to generate the concept 224. For example, the external database 324 includes a dictionary, an encyclopaedia or many web pages which may contain some information about the keyword “Bob”. It should be noticed that the keyword 322 is composed of one or a plurality of words. The words may be changed into synonyms of themselves, or other related words, but the disclosure is limited thereto.

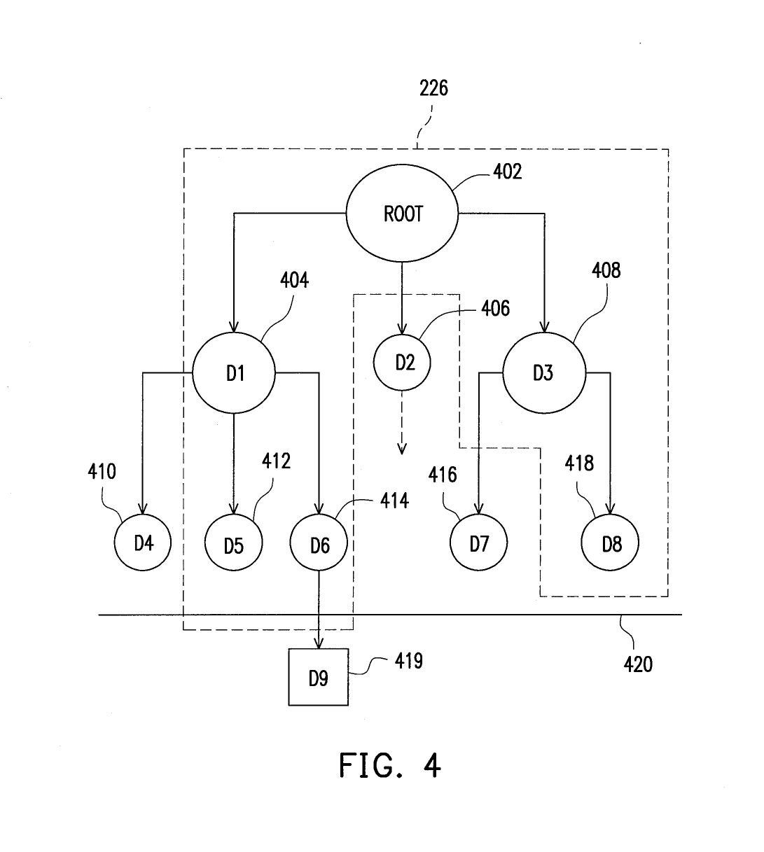

FIG. 4 is a diagram illustrating a semantic document set according to the first exemplary embodiment.

Referring to FIG. 4, after the concept discovery module 142 gets the keyword 322 of the main document, the document filter module 144 obtains the sub documents of the input documents 102 to generate a semantic document set 226. In the exemplary embodiments, the main document comprises at least one hyperlink or other types of relationships linked to the sub documents. For example, in FIG. 4, the hyperlink of the main document 402 is linked to the documents 404, 406 and 408. Furthermore, the documents 404 may comprise a hyperlink as well, and it is linked to the documents 410, 412 and 414. A hyperlink of the document 408 is linked to the documents 416 and 418. In other words, the document filter module 144 obtains the documents 404-419 (i.e. sub documents) according to the hyperlink of the main document 402. In addition, the document filter module 144 only collects the documents above the relationship depth threshold 420. To be specific, the document filter module 144 calculates a linking length of each of the sub documents, wherein the linking length is the number of the linking hopping to the main document 402. For example, the linking length of the document 414 is 2. The document 414 may comprise a hyperlink linked to the document 419, therefore, the linking length of the document 419 is 3. In the exemplary embodiment, the relationship depth threshold 420 is 3, and the document filter module 144 will not collect a document that the linking length thereof is larger than or equal to the relationship depth threshold 420. In other words, the document filter module 144 will not collect the document 419 when generating the semantic document set 226.

In addition, the document filter module 144 generates a keyword similarity of each of the sub documents. In detail, the keyword similarity is generated based on a degree of similarity between the keyword of the main document 402 and the keyword of each of the sub documents. For example, document filter module 144 compares a keyword of the main document 402 with a keyword of the document 404 to generate a keyword similarity of the document 404. If the generated keyword similarity is larger than a similarity threshold, the document filter module 144 will group the document 404 into the semantic document set 226. For example, if the document filter module 144 compares a keyword of the main document 402 with a keyword of the document 406 to generate a keyword similarity and determines that the keyword similarity is smaller than the similarity threshold, the document filter module 144 will not group the document 406 into the semantic document set 226.

Moreover, the document filter module 144 also obtains a semantic capacity of each of the sub documents in the semantic documents set 226. A semantic capacity is a degree indicating how noticeable a document is, and is used to filter out the documents which are not noticeable. For example, if a document is a biography of a person and another document is a web page of a social network of the same person, the semantic capacity of the former one will be larger than that of the other. If the semantic capacity of a sub document is lower than a capacity threshold, the document filter module 144 will not group the sub document into the semantic document set 226.

To generate a semantic capacity, the document filter module 144 obtains a plurality of words appeared on each of the sub documents and calculates a frequency of each of the words. And, the document filter module 144 generates a semantic capacity of each of the sub documents according to the frequency of each of the words appeared on each of the sub documents. To be specific, the frequencies of words appeared on one of the sub documents includes a first frequency and a second frequency. The document filter module 144 would generate the semantic capacity of the sub document according to a difference between the first frequency and the second frequency. If the difference is large, it means that the content of the sub document is targeted on only a few words, which makes the semantic capacity of the sub document large.

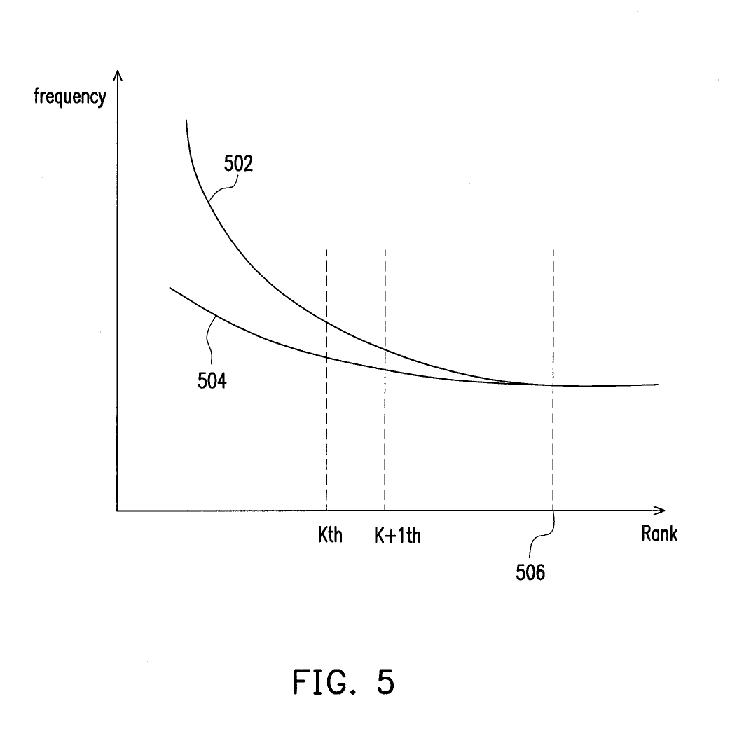

FIG. 5 is a diagram illustrating a curve of frequencies of words according to the first exemplary embodiment.

Referring to FIG. 5. The horizontal axis indicates words in a sub document, and the vertical axis indicates the frequency of a word. The curve 502 indicates a biography, and the curve 504 indicates a social network web page. The words are ranked according to the corresponding frequency (from high to low as shown in FIG. 5). In other words, the curve 502 describes the ranking of words of a biography, and the curve 504 describes the ranking of words of a social network web page. The curve 502 and the curve 504 are both long-tail curves. That is, the curve 502 and the curve 504 over the ranking threshold 506 are very similar. However, under the ranking threshold 506, the curve 502 is sharper than the curve 504, which indicates the frequencies of words of the biography is more concentrated. For example, both curve 502 and curve 504 have k^{th} frequency and (k+1)^{th} frequency under the ranking threshold 506, but the difference between the kₜₕ frequency and (k+1)^{th} frequency of the curve 502 will be larger than the difference between the kₜₕ frequency and (k+1)^{th} frequency of the curve 504. In the exemplary embodiment, the document filter module 144 makes the semantic capacity of the curve 502 more than that of the curve 504 in a statistical way. In detail, when obtaining a semantic capacity of a document, the document filter module 144 obtains a plurality of words from the document. The document filter module 144 also obtains a frequency of each of the words appeared on the document and ranks the words according to the frequencies in an order. Then, the document filter module 144 assigns a subtraction between a k^{th} frequency and a (k+1)^{th} frequency in the order as a random variable, wherein k in an integer smaller than a ranking threshold 506 and larger than 0. For example, the random variable is represented as the following formula (1).

ΔRank(F(K+1))˜F(K+1)−F(K),kε{0,H} (1)

Wherein ΔRank(F(K+1)) is the random variable, F(K+1) and F(K) are the (k+1)^{th} frequency and the k^{th} frequency, respectively, and H is the ranking threshold 506. The document filter module 144 calculates the variance of the random variable and takes the variance as the semantic capacity. In other words, if the variance of a sub document is smaller than the capacity threshold, the document filter module 144 will not group the sub document into the semantic document set 226.

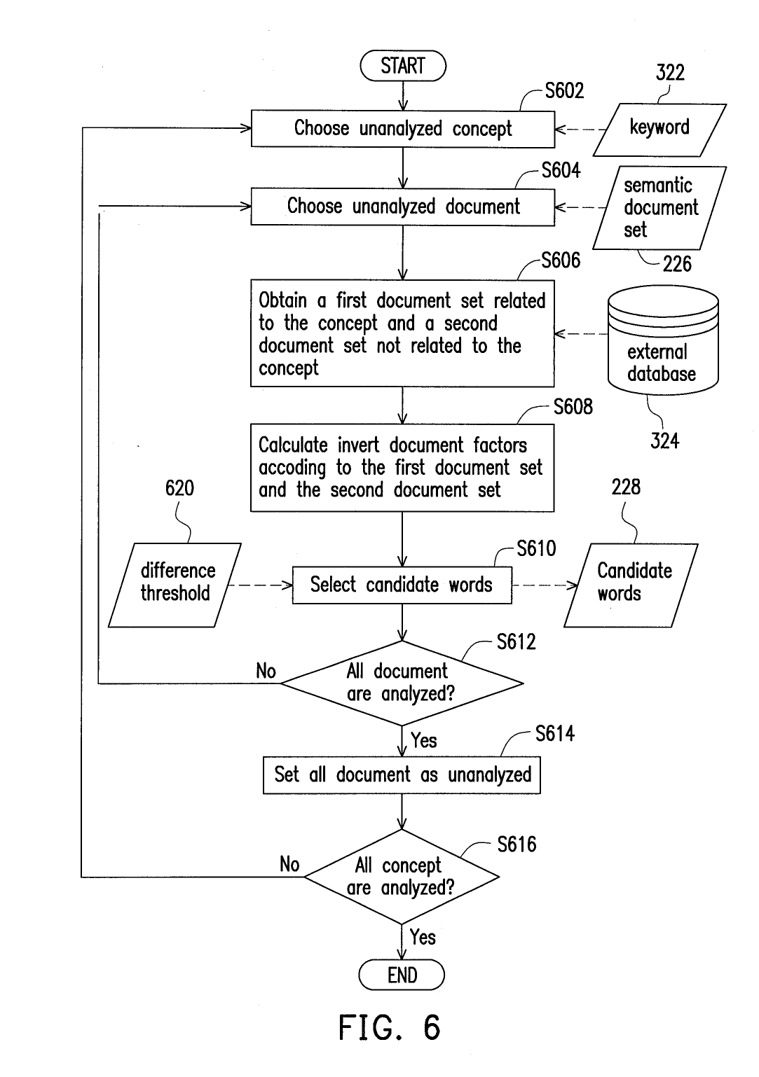

FIG. 6 is a flowchart of obtaining candidate words related to a document according to the first exemplary embodiment.

Referring to FIG. 6. In step S602, the document filter module 144 chooses an unanalyzed concept. In one exemplary embodiment, there would be more than one categories of keywords in keyword 322, so that there might be more than one corresponding concepts reflected from keyword 322. The document filter module 144 will process all the concepts. Then, in step S604, the document filter module 144 chooses an unanalyzed document form the semantic document set 226.

In step S606, the document filter module 144 obtains a first document set related to the chosen concept and a second document set not related to the chosen concept. For example, the chosen concept is “person” and the corresponding keyword is “Bob”. The document filter module 144 searches documents from the external database 324 according to the word “Bob” to generate the first document set. The document filter module 144 may chose another keyword (also referred as a second keyword) not related to the chosen concept “person”. For example, the second keyword is “plant”. The document filter module 144 searches documents from the external database 324 according to the second keyword to generate the second document set.

In step S608, the document filter module 144 calculates invert document factors of words in unanalyzed documents choosen in the step S604 according the first document set and the second document set. In detail, the chosen document has a plurality of words. Take a first word in these words as an example, the document filter module 144 calculates a first invert document factor of the first word according to the first document set. And, the document filter module 144 calculates a second invert document factor of the first word according to the second document set. To be specific, a invert document factor is a numerical statistic which reflects how important the first word is to a document set.

In step S610, the document filter module 144 selects the candidate words 228. In detail, if the difference between the first invert document factor and the second invert document factor is larger than a difference threshold 620, then the first word is chosen as one of the candidate words 228. For example, the process can be described as a formula (2).

W(c)=IDF(c|A)−IDF(c|B)>Z (2)

Wherein C is the first word, A is the first document set, B is the second document set, Z is the difference threshold, IDF( ) is function for calculating invert document factors, and W(c) is the difference between the first invert document factor and the second invert document factor.

In step S612, the document filter module 144 determines whether all the document in the semantic document set 226 are analyzed. If not, the document filter module 144 goes back to the step S604. Otherwise, the document filter module 144 goes to the step S614. In step S614, the document filter module 144 sets all the document in the semantic document set 226 as unanalyzed documents.

In step S616, the document filter module 144 determines whether all the concepts are analyzed. If not, the document filter module 144 goes back to the step S602. Otherwise, the process shown in FIG. 6 is terminated.

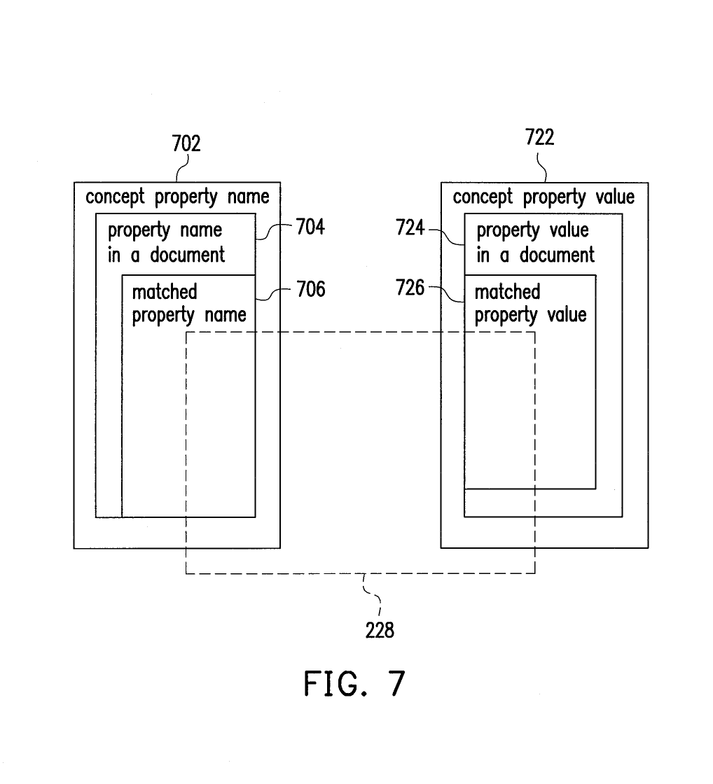

FIG. 7 is a schematic diagram illustrating the matching between property names and property values according to the first exemplary embodiment.

Referring to FIG. 7, after obtaining the candidate words 228, the metadata matching module 146 starts to choose words as annotations. To be specific, an item type has a plurality of properties, and each of the properties has a property name and a property value. The metadata matching module 146 matches the candidate words with the property names and property values. For example, in a sentence “My name is Bob”, the corresponding item type is “person”, which has a property and its property name is “name”. The metadata matching module 146 matches the word “My name” with the property name “name”, and the word “Bob” is taken as a property value. After annotating, the sentence would become “My name is <span itemprop=”name“>Bob</span>” with the format of Microdata. However, not every property name and every property value can be matched in the candidate words 228. For example, the property names in a concept (item type) have the scope 702, the property names in a document have the scope 704, and the property names matching the metadata protocol 222 have the scope 706. It should be noticed that the scope 702 is larger than the scope 704, and the scope 704 is larger than the scope 706. Similarly, the property values needed in a concept (item type) have the scope 722, the property values existed in a document have the scope 724, and the property values matching the metadata protocol 222 have the scope 726. The scope 722 is larger than the scope 724, and the scope 724 is larger than the scope 726. It should be noticed that in candidate words 228, some candidate property words are neither the property names nor the property values.

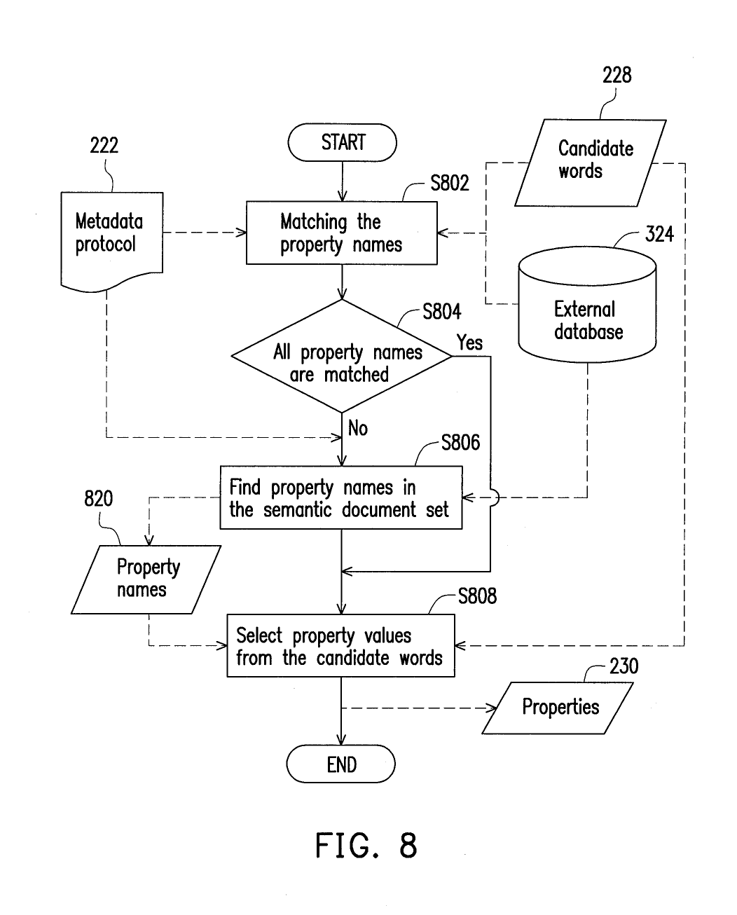

FIG. 8 is a flowchart of matching properties according to the first exemplary embodiment.

Referring to FIG. 8, in step S802, the metadata matching module 146 tries to match the property names of an item type with the candidate words according to the metadata protocol 222. For example, if the item type is “person”, then the property names may be “name”, “address”, and “title”, and the corresponding candidate words may be “Bob”, “1^{st}, Chicago avenue, Chicago”, and “senior engineer”, respectively. The metadata matching module 146 may make use of the external database 324. For example, the external database 324 has grammar rules or synonyms of words, but the disclosure is not limited thereto.

In step S804, the metadata matching module 146 determines whether all the property names are matched. As discussed above, not all the property names could be matched by candidate words 228. Therefore, if a property name (also referred as a first property name) is not matched, in step S806, the metadata matching module 146 then tries to match the first property name to the words in the semantic document set 226. For example, the metadata matching module 146 searches every word in the documents of the semantic document set 226 to match the first property name. Then, the metadata matching module 146 generates the property names 820 matching the metadata protocol 222. It should be noticed that, since the property names 820 are corresponding to words in a document, the locations of the property name 820 are referred as the locations of the corresponding words.

In step S808, the metadata matching module 146 selects property values from the candidate words 228. Since a property name is located, a corresponding property value could be found near the location of property name. Take a second property name as an example, the metadata matching module 146 selects a second candidate word among the candidate words, wherein a location of the second candidate word is closest to a location of the second property name. And, the metadata matching module 146 recommends or assigns the second candidate word as the property value corresponding to the second property name. In other exemplary embodiment, the metadata matching module 146 obtains a third property name, wherein a location of the second property name is next to a location of third property name. The metadata matching module 146 also obtains a fourth property name, wherein a location of the fourth property name is next to the location of the second property name. To be specific, the location of the fourth property name just succeeds the location of the second property name, and the location of the third property name just precedes the location of the second property name. The metadata matching module 146 would obtain a second candidate word located between the third property name and the fourth property name; and recommends or assigns the second candidate word as the property value corresponding to the second property name. After that, the metadata matching module 146 generates properties 230 in which all the property names and property values are found.

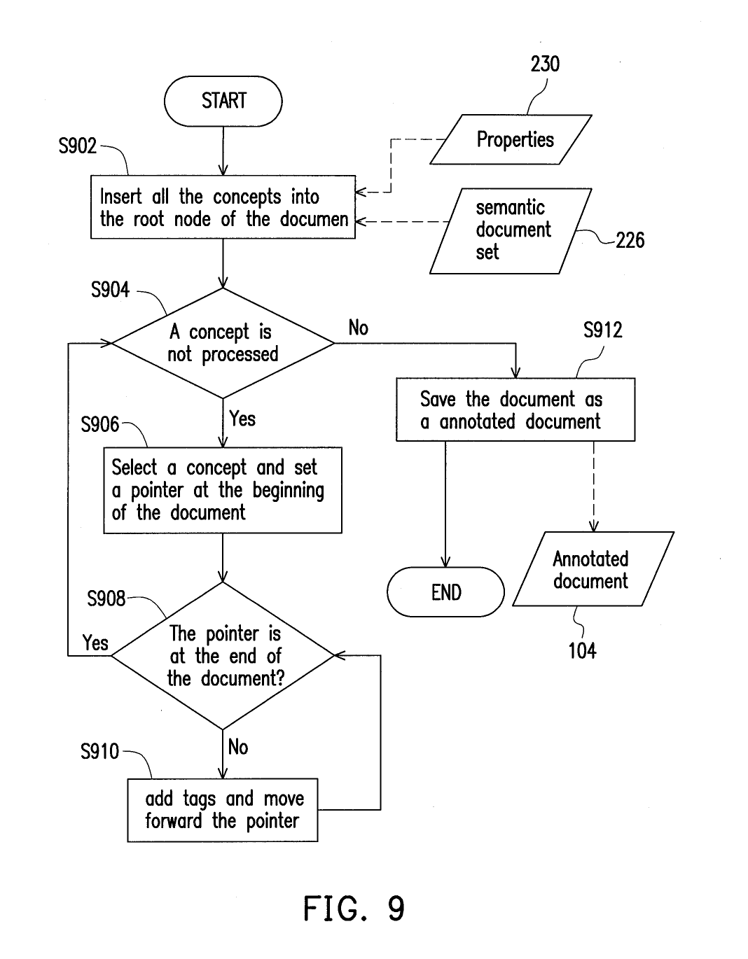

FIG. 9 is a flowchart of embedding properties as annotations according to the first exemplary embodiment.

Referring to FIG. 9, in step S902, the metadata matching module 146 inserts all the concepts into a root node of a document according to the properties 230 and the semantic document set 226. To be specific, for each document in the semantic document set 226, the metadata matching module 146 inserts an item type into the global scope (i.e. root node) of the document as a tag. For example, the inserted tag is “<body itemscope itemtype=”http://data-vocabulary.org/Person“>”. The inserted tag indicates the item type is “person”, the location of the tag is at the “body”, a global scope, of the document. If there are more than one item types, the metadata matching module 146 creates a virtual tag under the <body>. For example, if another item type is “organization”, the inserted tags are:

<body itemscope itemtype=”http://data-vocabulary.org/Person”>
<span itemscope itemtype=”http://data-vocabulary.org/Organization”>.

In step S904, the metadata matching module 146 determines whether a concept (item type) is not processed. If a concept is not processed, in step S906, the metadata matching module 146 selects the unprocessed concept and sets a pointer at the begging of the document. In step S908, the metadata matching module 146 determines if the pointer is at the end of the document.

If the pointer is not at the end of the documents, in step S910, the metadata matching module 146 tries to add tags and then moves forward the pointers. In detail, for every property value, the metadata matching module 146 adds property names as tags. If a property value is a text node between two tags, the property name is added as annotations. If a property value is a part of pure text or it crosses several node sectors, then the metadata matching module 146 creates a virtual tag in the global scope as annotations. For example, the original text of “<p><b>Allen Ezail Iverson<b>(born Jun. 7, 1975) is an American professional <a href=“/wiki/Basketball” title=“Basketball”>basketball</a>player” could be annotated as “<p><b itemprop=”name“>Allen Ezail Iverson</b>(born Jun. 7, 1975) is an American professional <span itemprop=”role“><a href=”/wiki/Basketball” title=“Basketball”>basketball</a>player</span>. </p>″. After that, the metadata matching module 146 moves the pointer forward and goes back to the step S908.

If the pointer is at the end of the document, the metadata matching module 146 goes back to the step S904. If every concept is processed, in step S912, the metadata matching module 146 saves the document as an annotated document, and generates the annotated documents 104.

After that, the user interface module 148 creates a user interface on a screen, and shows the annotated documents 104 on the screen. The user interface module 148 may also create another user interface and only shows the properties 230 on the user interface. A user may confirm the properties 230 shown on the interface by clicking a confirm button, but the disclosure is not limited thereto.

### Second Exemplary Embodiment

It should be noted, in the first exemplary embodiment, an example of recommending semantic annotations for web pages is described. However, the present disclosure is not limed thereto. In the second exemplary embodiment, general documents, such as portable document files (PDF) or Microsoft Word documents, may be annotated.

Hardware components of the second exemplary embodiment are substantially similar to that disclosed in the first exemplary embodiment, and components described in the first exemplary embodiment are applied to describe the second exemplary embodiment.

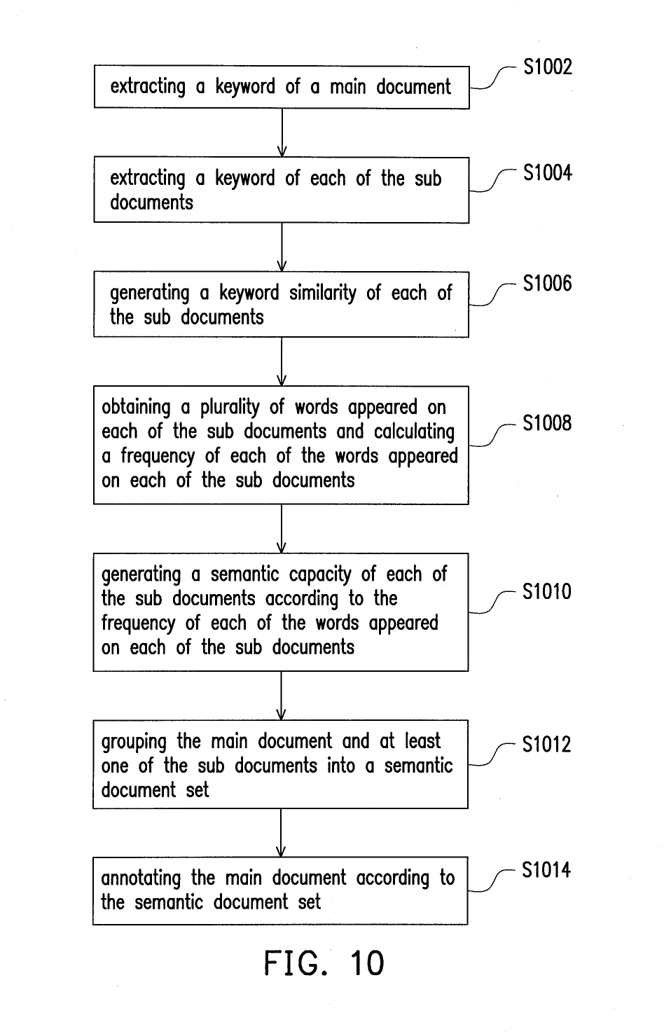

FIG. 10 is a flowchart of a method for recommending semantic annotations on general documents having a main document and a plurality of sub documents according to a second exemplary embodiment.

Referring to FIG. 10, in step S1002, the concept discovery module 142 extracts a or a set of keyword of the main document. In step S1004, the concept discovery module 142 extracts a or a set of keyword of each of the sub documents.

In step S1006, the document filter module 144 generates a keyword similarity of each of the sub documents, wherein the keyword similarity of each of the sub documents is generated based on a degree of similarity between the keyword of the main document and the keyword of each of the sub documents. Herein, the manner of generating a keyword similarity of a document is similar to the manner described in the first exemplary embodiment, and therefore it will not be repeated.

In step S1008, the document filter module 144 obtains a plurality of words appeared on each of the sub documents and calculating a frequency of each of the words appeared on each of the sub documents.

In step S1010, the document filter module 144 generates a semantic capacity of each of the sub documents according to the frequency of each of the words appeared on each of the sub documents. Herein, the manner of generating a semantic capacity of a document is similar to the manner described in the first exemplary embodiment, and therefore it will not be repeated.

In step S1012, the document filter module 144 groups the main document and at least one of the sub documents into a semantic document set based on the semantic capacities of the sub documents and the keyword similarities of the sub documents. Herein, the manner of grouping documents into a semantic document set is similar to the manner described in the first exemplary embodiment, and therefore it will not be repeated.

In step S1014, the metadata matching module 146 annotates the main document according to the semantic document set. Herein, the manner of grouping documents into a semantic document set is similar to the manner in the first exemplary embodiment, and therefore it will not be repeated.

As described above, the method and system for recommending semantic annotations in the above exemplary embodiments annotates a document according to a semantic document set instead of a single document and the sub documents grouped into the semantic document set are determined according to a semantic capacity of each sub document. Therefore, the document can be annotated more precisely about the conceptual topics related to the semantic document set 226.

The previously described exemplary embodiments of the present disclosure have the advantages aforementioned, wherein the advantages aforementioned not required in all versions of the present disclosure.

It will be apparent to those skilled in the art that various modifications and variations can be made to the structure of the present disclosure without departing from the scope or spirit of the present disclosure. In view of the foregoing, it is intended that the present disclosure cover modifications and variations of this disclosure provided they fall within the scope of the following claims and their equivalents.

What is claimed is:

1. A method for recommending semantic annotations on a plurality of input documents having a main document and a plurality of sub documents, the method comprising:
extracting a keyword of the main document;
extracting a keyword of each of the sub documents;
generating a keyword similarity of each of the sub documents, wherein the keyword similarity of each of the sub documents is generated based on a degree of similarity between the keyword of the main document and the keyword of each of the sub documents;
obtaining a plurality of words appeared on each of the sub documents and calculating a frequency of each of the words appeared on each of the sub documents;
generating a semantic capacity of each of the sub documents according to the frequency of each of the words appeared on each of the sub documents;
grouping the main document and at least one of the sub documents into a semantic document set based on the semantic capacities of the sub documents and the keyword similarities of the sub documents; and
annotating the main document according to the semantic document set.

2. The method for recommending semantic annotations according to the claim 1, wherein the sub documents includes a first sub document, and the step of generating the semantic capacity of each of the sub documents according to the frequency of each of the words appeared on each of the sub documents comprises:
ranking the frequencies of the words of the first sub document in an order;
assigning a difference between a k^{th} frequency and a (k+1)^{th} frequency in the order as a random variable, wherein k is an integer smaller than a ranking threshold and larger than 0; and
obtaining the semantic capacity of the first sub document according to a variance of the random variable.

3. The method for recommending semantic annotations according to the claim 2, wherein the step of grouping the main document and the at least one of the sub documents into the semantic document set based on the semantic capacities of the sub documents and the keyword similarities of the sub documents comprises:
grouping the first sub document into the semantic document set if the semantic capacity of the first sub document is larger than a capacity threshold and the keyword similarity of the first document is larger than a similarity threshold.

4. The method for recommending semantic annotations according to the claim 1, further comprising:
matching the keyword of the main document with an item type of a metadata protocol, wherein the item type comprises a plurality of properties and each of the properties comprises a property name and a property value.

5. The method for recommending semantic annotations according to the claim 4, further comprising:
selecting candidate words from the words appeared on the at least one of the sub documents grouped to the semantic document set.

6. The method for recommending semantic annotations according to the claim 5, wherein the words appeared on the at least one of the sub documents grouped to the semantic document set includes a first word,
wherein the step of selecting the candidate words from the words appeared on the at least one of the sub documents grouped to the semantic document set comprises:
obtaining a first document set from an external database according to the keyword of the main document;
obtaining a second document set from the external database according to a second keyword, wherein the second keyword is different from the keyword of the main document;
generating a first invert document factor of a first word according to the first document set and generating a second invert document factor of the first word according to the second document set; and
determining whether a difference between the first invert document factor and the second invert document factor is larger than a difference threshold; and
if the difference between the first invert document factor and the second invert document factor is larger than the difference threshold, identifying the first word as one of candidate words.

7. The method for recommending semantic annotations according to the claim 5, wherein the step of annotating the input document according to the semantic document set comprises:
matching each of the property names with the candidate words;
determining whether all of the property names are matched with the candidate words; and
if a first property name among the property names is not matched with the candidate words, matching the first property name with the words appeared on the at least one of the sub documents grouped to the semantic document set.

8. The method for recommending semantic annotations according to the claim 7, wherein the property names comprise a second property name, and the step of annotating the input document according to the document set further comprises:
selecting a second candidate word among the candidate words, wherein a location of the second candidate word is closest to a location of the second property name; and
assigning the second candidate word as the property value corresponding to the second property name.

9. The method for recommending semantic annotations according to the claim 6, wherein the property names comprise a second property name, and the step of annotating the main document according to the semantic document set further comprises:
obtaining a third property name, wherein a location of the second property name is next to a location of third property name and a location of a fourth property name is next to the second property name;
obtaining a second candidate word located between the third property name and the fourth property name; and
assigning the second candidate word as the property value corresponding to the second property name.

10. The method for recommending semantic annotations according to the claim 4, wherein the step of annotating the main document according to semantic document set comprises;
creating a virtual tag under a global scope of the main document; and
adding the item type into the virtual tag.

11. A system for recommending semantic annotations, the system comprising:
a memory, storing a plurality of instructions; and
a processor, coupled to the memory, configured to execute the instructions to execute a plurality of steps,
wherein the steps comprise:
extracting a keyword of a main document;
extracting a keyword of each of a plurality of sub documents;
generating a keyword similarity of each of the sub documents, wherein the keyword similarity of each of the sub documents is generated based on a degree of similarity between the keyword of the main document and the keyword of each of the sub documents;
obtaining a plurality of words appeared on each of the sub documents and calculating a frequency of each of the words appeared on each of the sub documents;
generating a semantic capacity of each of the sub documents according to the frequency of each of the words appeared on each of the sub documents;
grouping the main document and at least one of the sub documents into a semantic document set based on the semantic capacities of the sub documents and the keyword similarities of the sub documents; and
annotating the main document according to the semantic document set.

12. The system for recommending semantic annotations according to the claim 11, wherein the sub documents includes a first sub document, and the step of generating the semantic capacity of each of the sub documents according to the frequency of each of the words appeared on each of the sub documents comprises:
ranking the frequencies of the words of the first sub document in an order;
assigning a difference between a k^{th} frequency and a (k+1)^{th} frequency in the order as a random variable, wherein k is an integer smaller than a ranking threshold and larger than 0; and
obtaining the semantic capacity of the first sub document according to a variance of the random variable.

13. The system for recommending semantic annotations according to the claim 12, wherein the step of grouping the main document and the at least one of the sub documents into the semantic document set based on the semantic capacities of the sub documents and the keyword similarities of the sub documents comprises:
grouping the first sub document into the semantic document set if the semantic capacity of the first sub document is larger than a capacity threshold and the keyword similarity of the first document is larger than a similarity threshold.

14. The system for recommending semantic annotations according to the claim 11, further comprising:
matching the keyword of the main document with an item type of a metadata protocol, wherein the item type comprises a plurality of properties and each of the properties comprises a property name and a property value.

15. The system for recommending semantic annotations according to the claim 14, further comprising:
selecting candidate words from the words appeared on the at least one of the sub documents grouped to the semantic document set.

16. The system for recommending semantic annotations according to the claim 15, wherein the words appeared on the at least one of the sub documents grouped to the semantic document set includes a first word,
wherein the step of selecting the candidate words from the words appeared on the at least one of the sub documents grouped to the semantic document set comprises:
obtaining a first document set from an external database according to the keyword of the main document;
obtaining a second document set from the external database according to a second keyword, wherein the second keyword is different from the keyword of the main document;
generating a first invert document factor of a first word according to the first document set and generating a second invert document factor of the first word according to the second document set; and
determining whether a difference between the first invert document factor and the second invert document factor is larger than a difference threshold; and
if the difference between the first invert document factor and the second invert document factor is larger than the difference threshold, identifying the first word as one of candidate words.

17. The system for recommending semantic annotations according to the claim 15, wherein the step of annotating the input document according to the semantic document set comprises:
matching each of the property names with the candidate words;
determining whether all of the property names are matched with the candidate words; and
if a first property name among the property names is not matched with the candidate words, matching the first property name with the words appeared on the at least one of the sub documents grouped to the semantic document set.

18. The system for recommending semantic annotations according to the claim 17, wherein the property names comprise a second property name, and the step of annotating the input document according to the document set further comprises:
selecting a second candidate word among the candidate words, wherein a location of the second candidate word is closest to a location of the second property name; and
assigning the second candidate word as the property value corresponding to the second property name.

19. The system for recommending semantic annotations according to the claim 16, wherein the property names comprise a second property name, and the step of annotating the main document according to the semantic document set further comprises:
obtaining a third property name, wherein a location of the second property name is next to a location of third property name and a location of a fourth property name is next to the second property name;
obtaining a second candidate word located between the third property name and the fourth property name; and
assigning the second candidate word as the property value corresponding to the second property name.

20. The system for recommending semantic annotations according to the claim 14, wherein the step of annotating the main document according to semantic document set comprises:
creating a virtual tag under a global scope of the main document; and
adding the item type into the virtual tag.
